(19) United States
(12) Patent Application Publication
(10) Pub. No.: US 2005/0140031 A1
(43) Pub. Date: Jun. 30, 2005

(54) Method and device for pulverising liquids using gas flows

(76) Inventor: Luder Gerking, Berlin (DE)

Correspondence Address: BARNES & THORNBURG, 11 SOUTH MERIDIAN, INDIANAPOLIS, IN, 46204, US

(21) Appl. No.: 10/492,110

(22) PCT Filed: Oct. 10, 2002
(86) PCT No.: PCT/EP02/11368

(30) Foreign Application Priority Data
Oct. 11, 2001 (DE) 101 50 931.6

(51) Int. Cl. F02M 19/03

(52) U.S. Cl. 261/76; 261/78.1; 261/DIG. 75

(57) ABSTRACT

The invention relates to a method and a devise for pulversing liquids using gas flows. According to the invention, the liquid is guided through an outlet into a pulverisation chamber and is pulverised in fine droplets. The liquid jet leaving the outlet of a liquid channel is accelerated by a laminar gas flow which is continuously accelerated by means of a Laval nozzle, until the increasing pressure inside the liquid jet and the decreasing pressure in the gas flow leads to the explosion of the liquid jet and to the formation of droplets.

The invention relates to a process and a device for atomising liquids with the aid of gas streams and the use of such a device.

In the state of the art there are a number of atomising nozzles having different assignments of gas flow, in most cases air flow, to the liquids, in most cases round jets but also hollow jets or films. For example a liquid jet is guided from an outlet opening into an atomisation chamber, wherein by supplying lateral gas streams, the jet is shattered and liquid particles of different size are produced. The distribution of the particle size is thus relatively wide.

One application for the atomisation of liquids is combustion engines. In today's combustion engines of the Otto engine type, only rarely is the liquid fuel, mainly petrol, atomised in carburettors which carried out this task in decades satisfactorily in varied construction, but the fuel is injected into the suction pipe via nozzles of the widest variety of construction and supplied to the cylinders with the inspired air or it is injected directly into the combustion chamber of the cylinder. This has to do both with better utilisation of the fuel, adaptation to the required capacity and with the reduction of pollutants in the waste gas.

In diesel engines, only direct injection into the upper part of the cylinder, often in specially shaped combustion chambers, is suitable. The requirements of mixture formation from fuel and air are the same for both types, of engine, even if it may be different in details, namely to atomise the fuel into as fine as possible droplets in order to thus provide a large surface for combustion. Particular requirements are placed on the form of the mixture volume produced by injection, to ideally ensure that the entire combustion chamber is filled uniformly by the mixture, that is, as uniform as possible mixing of fuel and air is present, in the ideal case everywhere in the stoichiometrically adapted particular masses.

Uniform atomisation is desirable in addition to the internal combustion engines, such as Otto engines in two-stroke cycle or four-stroke cycle or diesel engines, also for other internal combustion engines, such as gas turbines and other apparatuses producing power from combustions, such as thrust mechanisms with their combustion chambers and also for heating boilers and the like. The fuels are thus liquid fuels and the gases for combustion are usually air, by which they are designated below, even if it is not air but also its mixture with gases assisting combustion.

For pure pressure atomisation according to the state of the art, the required energy is introduced into the liquid by pressure, wherein the liquid jet emerging from an opening, for example the injection nozzle, tears open in the atmosphere to be regarded as approximately dormant with respect to it, due to disordered action of shearing stress, and forms droplets by means of the action of surface tension. This is a flow path which is increasingly turbulent due to the fundamentally high velocities in flow direction. The consequence is greater differences in the droplet sizes and also a relatively high energy expense.

For the pressure atomisation of fuels, such as heating oil in fire chambers of heating boilers or combustion chambers of gas turbines, equally when colour-spraying, the same takes place as previously described, which is why two-component nozzles liquid-gaseous are often used here for better distribution of the droplets produced and to achieve higher finenesses, to a limited extent also for narrower distribution of their particle sizes. As mentioned above, atomisation also takes place here largely in the turbulent flow field.

Other applications for atomisation into fine liquid particles are the applications for paints, brighteners, moisteners and the like.

The object of the invention is thus to provide a process and a device for atomising liquids with the aid of gas streams, with which the liquid in as fine as possible droplets are achieved in narrow and/or controlled distribution.

This object is achieved according to the invention by the features of the main claim and the sub-claim.

According to the atomisation of the invention, a liquid jet of preferably round cross-section emerging from ar opening is accelerated by a preferably concentrically engaging gas flow of shorter diameter by means of shearing forces until it explodes. This particular principle designated in the meantime also as the Nanoval process, has proved to be advantageous in the atomisation of metal melts (German 3 311 343), in that fine particles are produced in narrow distribution and are produced in good spherical form as powder. The atomisation of the invention is essentially determined by the mass flows of the two media gas and liquid and the surface tension and viscosity of the liquid. It is thus a question of gas flows in the range from sound velocity to supersonic velocity, for air flows thus round and above a good 300 m/second. The gas flow around the liquid jet is laminar and is continuously accelerated. A Laval nozzle of convergent-divergent cross-section arranged around the injection nozzle, more likely slightly below it, serves for this. By reducing the jet diameter, the pressure against the externally acting surface tension rises in its interior. Since the gas is accelerated, the pressure in it decreases and there is exploding of the liquid jet if the surface forces are no longer able to hold the jet together. This takes place as a characteristic of the process suddenly and for example in the region of the narrowest cross-section of the Laval nozzle or in flow direction thereafter. The liquid droplets are expanded towards the side, since the sudden explosion as a consequence of the predominant internal pressure is superimposed on the forward pulse of the liquid jet.

Depending on the use of the device of the invention and of the process of the invention, various advantages are produced. In internal combustion engines, mixture formation is improved, in the atomisation of heating oils in burners the efficiency is increased and the harmfulness of the waste gases reduced, in atomisation nozzles for paints, brighteners, moisturisers—here due to the laminar type of atomisation low noise—and likewise the advantage of finer particles in narrow distribution is utilised. For combustion engines, better utilisation of the fuel, adaptation to the required capacity and also reduction of the pollutants in the waste gas is produced. The distribution of the droplet size does not vary so greatly, in particular droplets which are too big are not produced when it is not required, as for diesel engines, sometimes too different ranges when filling the combustion chamber, and the entire combustion chamber is filled uniformly by the mixture.

Advantageous developments and improvements are possible due to the measures indicated in the sub-claims.

If the ratio of the pressures is increased upstream and downstream of the Laval nozzle, sound velocity is produced in the narrowest cross-section of the Laval nozzle at the critical pressure ratio, which for air is 1.89, and supersonic velocity is then produced in the gas during finisher increase.

If the pressure downstream of the Laval nozzle is higher or lower than corresponds to the flow path according to its contour, that is not adapted, for supersonic velocity there is a compression shock downstream of the Laval nozzle or a further expansion. This may be repeated so that shock fronts follow expansion sections until the pressure is relieved to that of the subsequent chamber, for example a mixture-formation chamber, a suction pipe or directly to a combustion chamber.

According to the invention, expansion of the mixture formed from air and liquid may be utilised by expansion at one corner, the so-called Prandtl-Meyer flow, according to which supersonic flow expands at one corner in the subsequent chamber, and specifically in considerable expansion to over 90° to the original flow direction. A precondition is supersonic flow before and a further expansion possibility due to a lower pressure following after the corner. The invention makes use of the possibility of sudden expansion of a supersonic jet. Mixing of liquid, for example fuel and air, may be improved by the dilution and shock waves.

Mixture production by an accompanying air flow which is a part, but also the total combustion air, is important in the process of the invention and the device, particularly for the application in the motor vehicle field. First of all a pure air flow may thus be blown into the cylinder, which is used at the same time for rinsing the combustion chamber, and the fuel jet may then be introduced into the existing air flow, but air and fuel may also flow at the same time. The parallel flow between gas and liquid holds the liquid jet together until the point of explosion, and specifically longer than this takes place for other atomisation processes. The energy expense is lower than for the state of the art of pressure atomization.

The device and the process according to the invention are designed so that up until explosion in both media, gas and liquid, laminar flow exists. Fundamentally the accelerated gas flow of the invention serves for this, whereas a delayed flow such as during injection in dominant air is subject to destabilisation and turbulence is initiated. In the invention, only after explosion in or after sound transmission is there shock waves and dilution waves and then also turbulence. However, the droplets are already formed there. Both shock waves in the supersonic range and turbulence, promotes mixing of the droplets formed in the laminar flow with the air, in the case of combustion engines, of the fuel droplets with the combustion air.

The two-component atomisation device of the invention may also be used, released from the combustion process, that is subsequent to it, to reduce the waste gas pollutants, as takes place during partial load with waste gas return or during separate treatment of the mixture, for example using urea

Exemplary embodiments of the invention are shown in the drawing and are illustrated in more detail in the description below.

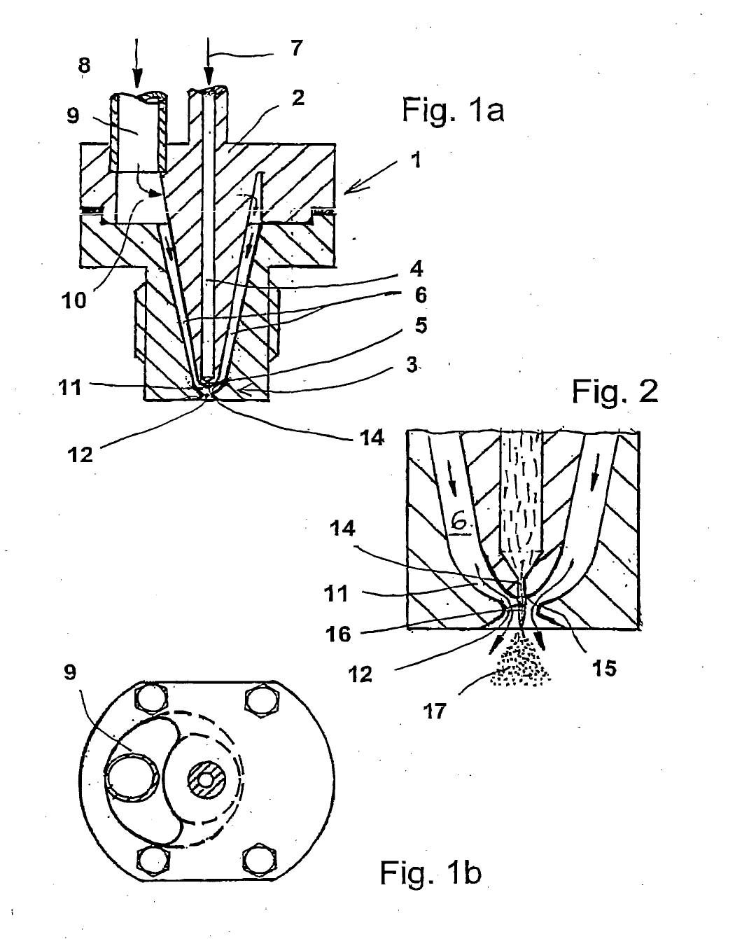

FIG. 1a shows a device for atomisation of fuel with rotationally symmetrical fuel outlet in the centre and air flow in the surrounding annular gap in a sectional representation, and

FIG. 1b shows the plan view corresponding to FIG. 1a,

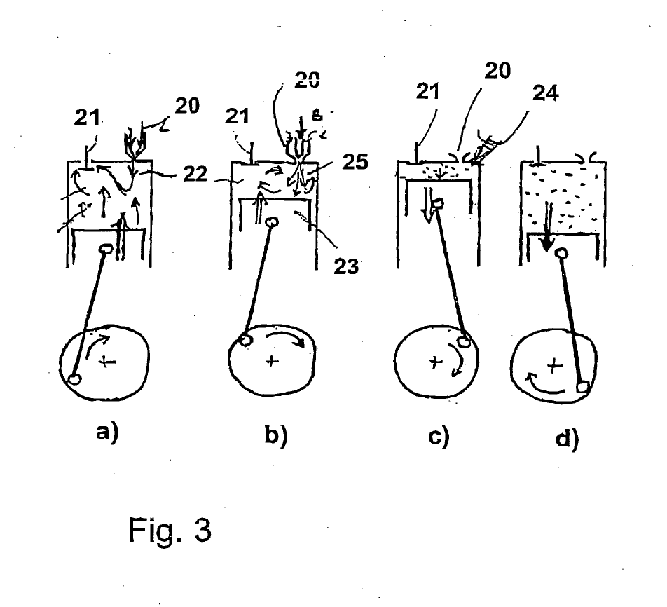

FIG. 2 shows an enlarged view of the lower part of FIG. 1a to illustrate the flow-mechanical events of atomisation,

FIGS. 3a to 3d shows the schematic representation of a working cycle of a two-stroke cycle engine with atomisation according to the invention,

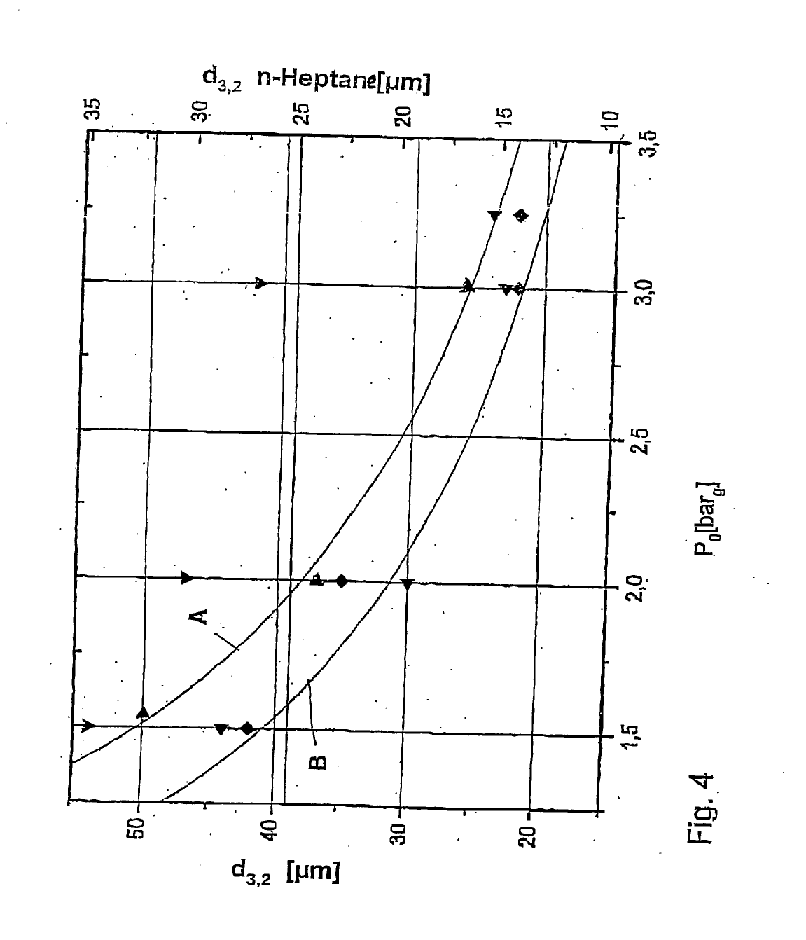

FIG. 4 shows the representation of test results of atomisation having droplet sizes depending on the pressure, and

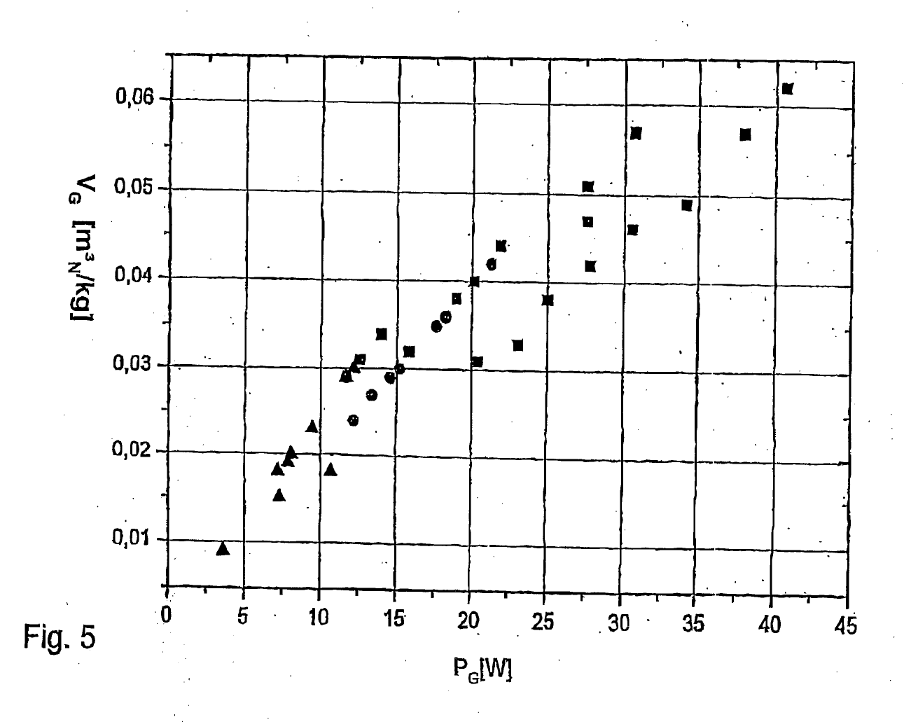

FIG. 5 shows the dependence of gas consumption as a function of the required compression energy for atomisation air.

FIGS. 1a and 1b show the essential parts of a device for atomising according to the invention, wherein in the present case, the device is described as an injection device for application in the motor vehicle field. The injection or atomisation device has a housing 1, which comprises a first art 2 with a passage bore forming the liquid or fuel channel 4 and an annular chamber 10. The liquid or fuel channel 4 is connected to a liquid or fuel supply not shown, whereas a distributor piece 9 connected to the annular chamber 10 is connected to a gas or air source not shown. Furthermore, a lower part 3 of the housing is provided, in which a Laval nozzle 5 is designed to be open towards an atomisation chamber. The upper part 2 is inserted and centred in the lower part so that an annular gap channel 6 is formed between them, which is connected to the annular gap 10. Furthermore, the fuel channel 4 leads into a capillary 14, which in turn terminates in the region of the narrowest cross-section 12 of the Laval nozzle 5 optionally also slightly underneath.

The device corresponding to FIGS. 1a and 1b is attached, for example to a suction pipe of the engine or directly on the cylinder head or on the combustion chamber of a gas turbine. They are thus fundamentally small dimensions. Hence, for example the throughflow cross-section of the liquid channel 4 in the upper part is only in the millimetre range and the outlet 15 of the capillary 14, depending on engine capacity or cylinder, for which the mixture is produced, in the tenth of a millimetre range, and accordingly the internal diameter for the annular gap channel 6, which is tapered towards the lower region 11, is only a few millimetres.

The liquid fuel is introduced into the liquid channel 4 according to the arrow 7, whereas the air flows into the distributor piece 9 along the arrow 8 and from there is distributed in the annular chamber 10 and flows into the annular gap channel 6. In the tapering lower region 11, the air velocity increases continuously until it reaches the narrowest cross-section 12 of the Laval nozzle 5. If the critical pressure ratio is exceeded, sound velocity prevails here, but no longer. As already stated, the capillary 14 terminates, usually slightly above the narrowest cross-section of the Laval nozzle 5.

Atomisation is illustrated in more detail using FIG. 2. The liquid jet 16 of the fuel emerges from the outlet opening 15 of the liquid channel 4 or the capillary 14. The accelerated air flow coming from the annular gap chamber 6, and which is indicated by the arrows, meets it laterally. This has a higher velocity than the liquid jet 16 as a result of appropriate pressure adjustment and disperses it to smaller diameters due to shearing stress. The air flow in the Laval nozzle 5 is thus accelerated due to the cross-section which decreases in the flow direction and in the narrowest cross-section 12 there is sound velocity, if the critical pressure ratio is achieved or exceeded by the initial pressure of the gas flow and the counter-pressure in the atomisation chamber. The expansion following the narrowest cross-section 12 of the Laval nozzle 5 leads to supersonic flow if adequate pressure is still present. Acceleration of the liquid jet thus consumes energy which comes from the air flow. Whereas the pressure in the air flow decreases, that in the liquid jet 16 increases by the action of the surface tension in the decreasing diameter and there is explosion of the liquid jet to form droplets 17, if the internal pressure outweighs the external pressure. The mixture of air and fuel formed is moved in a diverging volume of a “banner”.

The considerable expansion described at one corner may follow an expansion of the Laval nozzle 5 after the narrowest cross-section, also by retracing of the contour, so that a corner or even a rebound is formed, which permits sudden expansion of the liquid-gaseous medium. The precondition is a supersonic flow beforehand. Considerable expansion of the mixture, as generally required, can thus be achieved on a short path. Deflection is greater, the greater the supersonic velocity in the expanded part of the Laval nozzle 5, that is the higher the Mach number, which represents the ratio of the velocity at the outlet of the Laval nozzle to the sound velocity in the narrowest cross-section of the Laval nozzle.

During atomisation of the liquid medium fuel, it is possible to produce very small particles in the range 2 to 10 μm, for higher gas velocities still slightly below that, as far as or in the nano region. Since beforehand a monofilament of significantly smaller diameter than that of the original liquid jet leaving the capillary 14 was dispersed, coarse droplets are deposited from the start and generally atomisation has considerably lower scattering in the particle sizes than in the state of the art. Hence, the scattering measure d₈₄/d₅₀=1.5 to 1.9, whereas it lies between 2.3 and 3 in the better cases for conventional atomisation processes. Apart from special cases, in which a heterogeneous mixture is to be produced, the production of fine fuel droplets in non-considerably deviating particle sizes is advantageous for combustion.

During this atomisation by exploding, that is not for example by shattering into waves, shattering or stripping of a liquid jet, very good mixing with the surrounding air is produced, because due to exploding, the droplets formed, which are deformed by the action of surface tension to form structures similar to spheres, diverge and hence advantageously enlarge the mixing chamber right at the start of their production.

Instead of rotationally symmetrical flow of liquid and gas, atomisation may also be effected from a slot, wherein the Laval nozzle is then also formed as a slot. Several round liquid outlet nozzles arranged at a distance from one another may also be assigned to a slot-like Laval nozzle. The slot-like design of the outflow opening permits greater throughputs, but scatters the distribution of the droplet sizes wider, because thicker drops are formed at the edges. This may, as described, be desirable in some cases.

The production of a mixture of fuel and air according to the invention requires an air flow and increased pressure, even considerable pressures during injection directly into the compressed combustion chamber above a cylinder. An additional compressor for the partial stream of air for atomisation is a further expense both in terms of machine technology and further susceptibility of the engine and additional space requirement. When using the process or the device of the invention, this increased expense would thus have to be weighed with the improved combustion effect due to better atomisation. However, in a combustion engine, states of increased pressure in temporal sequence are present for reciprocating piston engines and for gas turbines in the associated compressors running in most cases on a shaft. They may be utilised for the increased pressure requirement of the atomisation air, be it that it is a question of continuous atomisation of the fuel, such as for example for gas turbines, or intermittent, as in most cases for Otto and diesel engines. The previously achieved higher pressures of a different cylinder may thus be utilised for mixture formation in a cylinder and compressed air in storage containers may be fed from cylinders via opening and closing valves. Such processes are known and are indicated, for example in U.S. Pat. No. 2,134,786 or German 3 732 259.

FIG. 3 shows schematically a further exemplary embodiment of the invention, wherein here it is a question of the working-cycle of a two-stroke cycle engine. This is a measure in which the engine capacity may be increased for given expense with atomisation by means of surrounding combustion air jets of high velocities. In this exemplary embodiment, a cylindrically controlled injection nozzle 20 is used corresponding to the device according to the invention, which leads into a cylinder chamber 22. Furthermore, the cylinder has an outlet valve 21. According to FIG. 3a, first of all only air flows into the cylinder chamber through injection nozzle 20 and assists evacuation of combustion gases from the cylinder chamber 22. The waste gases and additional air from the nozzle 20 leave the cylinder chamber 22 during upward stroke of the piston 23 via the valve 21. In the working cycle according to FIG. 3b, the outlet valve 21 is closed and via the injection valve according to the invention 20, fuel, accompanied by the continuing air flow is supplied in the upward stroke of the piston 23, wherein the fuel jet explodes and forms the mixture 25. This mixture is ignited according to FIG. 3c by a spark plug 24 and the expansion stroke follows in FIG. 3d and the working cycle starts anew.

Such a two-stroke cycle engine could also be realised without a valve if the outlet of the waste gas is implemented in known manner via slots laterally on the cylinder. The atomisation nozzle may also blow from an angle at the bottom to the top and evacuation of waste gas may be better effected.

In the diesel engine, the pressures are thus known to be very much higher than for the Otto engine and an injection nozzle according to the device of the invention should be used, hence it must be designed for these pressures in order to fulfil the requirement for self-ignition or additional ignition must take place, for example by means of spark plugs.

FIGS. 4 and 5 show results in the atomisation of water with air by means of the device of the invention. The Sauter diameter d_{3,2} serves as a measure of the droplet size, wherein the droplets are accepted in spherical form—which they also are in very good approximation for not too high tenacity of the liquid and the generally high surface tension. The Sauter diameter is formed from the ratio of the volume of the spheres V_{K} to their surface area A_{K} and it is d_{3,2}=6 V_{K}/A_{K}.

In the test according to FIG. 4, the overall nozzle had as a structural dimension an external diameter of 18 mm, an overall height of 80 mm, wherein the air supply channel 6 according to FIG. 1 coaxially to the liquid channel 4 had an annular gap of average diameter 8 mm and a width of 2 mm and was then tapered at the lower region 11 in FIG. 1 to the narrowest Laval nozzle diameter between 0.7 and 1.2 mm, concentrically to the liquid outlet through the capillary 14. The diameter of the outlet 15 was between 0.6 and 1 mm.

The Sauter diameter d_{3.2} was measured by an apparatus from Messrs. Malvern, the liquid was water and air was used as atomisation gas.

It can be seen from FIG. 4 that the particle diameter d_{3,2} is reduced with increasing excess pressure p₀ of the air with respect to atmosphere before entrance into the nozzle. It thus lay in the average of the measuring series in the range between curves A and B shown by different signs. The distance from the outlet 15 from the liquid capillary 14 to the narrowest cross-section 12 of the Laval nozzle 5 was changed. Thus the following denote
▾very considerable distance
♦considerable distance
[symbol] short distance
[symbol] very short distance

The results show that the size of the particles may be controlled by the flow conditions in the region between liquid outlet and narrowest cross-section of the Laval nozzle, its throat.

In FIG. 4, the Sauter diameter for n-heptane is indicated on the right of the ordinate, and is the model liquid for atomisation nozzles in the field of internal combustion engines. The latter may be estimated from that for water.

FIG. 5 shows the gas consumption V_{G} in standard cubic metres of air per kg of water as a function of the required compression energy P_{G} in watts for the atomisation air. The individual signs of the diagram show the measured values for the Sauter diameter in water. When achieving smaller droplet diameters, given by the squares in the diagram, the values vary more, which is due to the fact that geometrical changes in the liquid nozzle and the Laval nozzle and their assignment to one another were made. The diagram should serve to represent the basic conditions of this type of atomisation aid approximately achievable values. For the measured values of Sauter diameter in water, the values being produced-for n-heptane may be estimated, approximately as follows:

| | Water | | n-heptane | |
|---|---|---|---|---|
| ▪ | <31 | μm | <20 | μm |
| ● | 31 . . . 39 | μm | 20 . . . 25 | μm |
| ▴ | >39 | μm | >25 | μm |

1. A process for atomising liquids atomizing a liquid with the aid of a gas stream, in which the liquid is introduced from an outlet opening into an atomization chamber and atomised wherein the liquid jet emerging from the outlet opening is accelerated by a laminar gas flow continuously accelerated by means of a Laval nozzle, until the pressure increasing in the interior of the liquid jet and the pressure decreasing in the gas flow leads to atomization of the liquid.

2. The process according to claim 1 wherein the pressures upstream and downstream of the Laval nozzle are adjusted so that the speed of the gas stream at the narrowest cross-section of the Laval nozzle is about the speed of sound.

3. The process according to claim 1 wherein the liquid jet enters a Prandtl-Meyer gas flow at the end of the Laval nozzle.

4. The process according to claim 1 wherein the liquid jet has a round cross-section and is surrounded concentrically by the gas flow.

5. The process according claim 1 wherein the liquid is fuel and the fuel-gas mixture being produced in the atomization chamber is combusted.

6. The process according to claim 5 wherein the fuel jet is injected with the gas flow into at least one of a cylinder of an engine, the suction pipe of an engine, a combustion chamber of a gas turbine, and a fire chamber of a boiler.

7. The process according to claim 5 wherein, before injection of the fuel, gas flows into the cylinder to evacuate combustion gases and then the fuel jet is introduced into the gas flow to produce the fuel-gas mixture.

8. The process according to claim 5 wherein at least two cylinders are used and the pressure requirement for acceleration of the gas flow to form the mixture for a cylinder is recovered from the previously achieved higher pressures of a different cylinder.

9. The process according to claim 6 with a combustion chamber of a gas turbine and at least one compressor wherein the pressure requirement for acceleration of the gas flow to form the mixture for the combustion chamber is recovered from the higher pressures of the compressor.

10. A device for atomizing a liquid with the aid of a gas stream with a liquid channel having an outflow opening and which leads to an atomization chamber wherein a gas channel emerges in a Laval nozzle and is assigned to the liquid channel, wherein the narrowest cross-section of the Laval nozzle is arranged at one of the following locations: around the outflow opening; slightly above the outflow opening; and, below the outflow opening.

11. A device according to claim 10 wherein the gas channel and the Laval nozzle are designed so that the gas flow guided in the gas channel and the Laval nozzle is continuously accelerated and is laminar.

12. A device according to claim 10 wherein the Laval nozzle is widened towards its outlet so that if the stream from the outlet is exiting at the velocity of sound, the velocity of the stream at a narrower cross section upstream from the outlet is supersonic.

13. A device according to claim 10 wherein the outlet opening and the Laval nozzle are essentially circular in cross section.

14. A device according to claim 10 wherein the outlet opening and the Laval nozzle are slot-like.

15. A device according to claim 10 wherein the gas channel surrounds the liquid channel and is formed as one of an annular gap channel and a slotted gap channel.

16. Use of a device according to claim 10 in a combustion engine for producing a fuel-gas mixture.

17. Use of a device according to claim 10 in a combustion engine as at least one of an injection nozzle into a cylinder and an injection nozzle into a suction pipe.

18. Use of a device according to claim 10 as an atomization nozzle of fuel in at least one of a combustion chamber of a gas turbine and a fire chamber of a boiler.

19. The process according to claim 2 wherein the liquid jet enters a Prandtl-Meyer gas flow at the end of the Laval nozzle.

20. A device according to claim 11 wherein the Laval nozzle is widened towards its outlet so that if the stream from the outlet is exiting at the velocity of sound, the velocity of the stream at a narrower cross section upstream from the outlet is supersonic.
